(19) United States
(12) Patent Application Publication
(10) Pub. No.: US 2009/0023484 A1
(43) Pub. Date: Jan. 22, 2009

(54) Apparatus and Method for Carrying and Using a Cell Phone

(76) Inventor: Bonnette Louise Macklin, Easton, VA (US)

Correspondence Address: MILES & STOCKBRIDGE PC, 1751 PINNACLE DRIVE, SUITE 500, MCLEAN, VA, 22102-3833, US

(21) Appl. No.: 12/175,672

(22) Filed: Jul. 18, 2008

Related U.S. Application Data
(60) Provisional application No. 60/959,919, filed on Jul. 18, 2007.

(51) Int. Cl. H04M 1/05

(52) U.S. Cl. 455/575.6

(57) ABSTRACT

The present invention relates generally to electronic component carrying devices, and more particularly to cell phone carrying devices that are worn around a user's neck to provide easy access to the electronic component, for example, a cell phone. In accordance with an embodiment of the present invention, an electronic component holder includes a body portion having a top, a bottom, a front including a left edge and a right edge, and a back including a left edge and a right edge, the left edge of the front being connected to the left edge of the back and the right edge of the front being connected to the right edge of the back. The body portion being tapered downwardly from the top to the bottom and forming an open channel between the top and the bottom and adapted to securely receive and retain an electronic component. The device may further include a fabric strap having a left end and a right end, where the left end and the right end of the fabric strap are each attached to the top end of the body portion.

### CROSS-REFERENCE TO RELATED APPLICATIONS

This application claims benefit of priority to U.S. Provisional Patent Application No. 60/959,919, filed Jul. 18, 2007 and which is herein incorporated in its entirety by reference.

### FIELD OF THE INVENTION

The present invention relates generally to cell phone carrying devices, and more particularly to cell phone carrying devices that are worn around a user's neck to provide easy access to the cell phone.

### BACKGROUND

In general, people who live alone, especially the elderly and/or disabled, need to have a cell phone easily accessible at all times to ensure their safety by providing quick communication with family, friends and emergency services. Unfortunately, current devices for the storage, carrying and use of cell phones are not easy or convenient for many people to use. For example, but not limited to, individuals confined in a wheelchair frequently have no place to keep a cell phone, because they often are not wearing clothes that have pockets, are not wearing a belt on which most phone cases are designed to attach or clip, or, if clipped to a belt, is uncomfortable and/or difficult to reach. Alternatively, they may have pockets only in their pants from which it also can be extremely difficult for an elderly, disabled, or wheelchair-bound person to retrieve their cell phone. In addition, embodiments of the present invention are not limited to use by the elderly and/or the disabled, they also may be used by anyone who is busy using their hands. For example, but not limited to, nurses, doctors, therapists, dog walkers, hair dressers, shoppers, mothers, bikes, sports enthusiasts, etc.

### BRIEF DESCRIPTION OF THE DRAWINGS

FIG. 1 is a front view of an electronic component carrying neck sleeve, for example, but not limited to, a cell phone neck sleeve, in accordance with an embodiment of the present invention.

FIG. 2 is a front view of a flip-style cell phone in the cell phone neck sleeve of FIG. 1 being worn around the neck of a person, in accordance with an embodiment of the present invention.

FIG. 3 is a front perspective view of the flip-style cell phone and the cell phone neck sleeve of FIG. 2 being showing the flip-style cell phone partially open, in accordance with an embodiment of the present invention.

FIG. 4 is a front view of a person with a strap from a cell phone neck sleeve hanging around a person's neck and the cell phone neck sleeve with a cell phone installed therein stored in a shirt breast-pocket of the person, in accordance with an embodiment of the present invention.

FIG. 5 is a front view of a person with a strap from a cell phone neck sleeve hanging around a person's neck and the cell phone neck sleeve with a cell phone installed therein stored in a shirt side-pocket of the person, in accordance with an embodiment of the present invention.

FIG. 6 is a front view of a picture of an actual cell phone neck sleeve, in accordance with an embodiment of the present invention.

FIG. 7 is a back view of a picture of an actual cell phone neck sleeve, in accordance with an embodiment of the present invention.

FIG. 8 is a view of an inside surface of a cell phone neck sleeve that opens with the use of a hook and loop fabric closure or some other closing means attached to one side and to an adjacent edge of the back of the cell phone neck sleeve to permit the easy insertion and/or removal of a cell phone from the cell phone neck sleeve, in accordance with another embodiment of the present invention.

FIG. 9 is a front perspective view of a straight, non-flip-style cell phone in a cell phone neck sleeve, in accordance with an embodiment of the present invention.

FIG. 10 is a view of an inside surface of a cell phone neck sleeve that opens with the use of a hook and loop fabric closure (e.g., Velcro) or some other closing means attached to one side and to an adjacent edge of the back of the cell phone neck sleeve to permit the easy insertion and/or removal of a cell phone from the cell phone neck sleeve, in accordance with yet another embodiment of the present invention.

### DETAILED DESCRIPTION

In accordance with one embodiment of the present invention, a cell phone neck sleeve may include a body portion having, for example, but not limited to, a 2 inch by 2½ inch body portion having a top, a front, a back, and a bottom, where the body portion may be slightly tapered inward at the bottom of the body portion. The top and bottom each defining openings and a channel extending therebetween. The body portion may be adapted to receive a cell phone in the opening defined by the bottom and fixedly hold the cell phone in an upside down position in the body portion. In this upside-down position, the cell phone is worn around the neck of a person ready to be used with the keyboard and screen in the correct direction without having to turn the phone.

A fabric strap may be attached at opposite sides of the top of the top of the back of the body portion to form a loop. The loop of the fabric strap may be adapted to fit around a person's neck, which results in the cell phone hanging upside down and being in position to be immediately used with minimal effort.

In accordance with another embodiment of the present invention, a cell phone neck sleeve may include a body portion having, for example, but not limited to, a 2 inch by 2½ inch by ¼-½ inch body portion having a top, a front, a back, a first side connected to a first edge of the front and a first edge of the back, a second side connected to a second edge of the front and a second edge of the back, and a bottom, where the body portion may be slightly tapered inward at the bottom. This tapering helps to hold the cell phone in the cell phone neck sleeve. The addition of the sides permits thicker cell phones to be accommodated in the cell phone neck sleeve.

A fabric strap may be attached to top ends of each of the first side and the second side at outer edges of the top of the body portion to form a loop. The loop of the fabric strap may be adapted to fit around a person's neck, which results in the cell phone hanging upside down and being in a position to be immediately used with minimal effort.

In this and other embodiments, a clear soft piece of vinyl or other clear protective material may be provided and that is adapted to be secured to the top or front of the flip-type cell phone that is not inside the body portion. This piece of vinyl is adapted to provide protection for the top or front of the flip-type phone.

In accordance with other embodiments of the present invention, the body portion may be adapted in size to receive and hold straight, non-flip-type cell phones including, for example, but not limited to, a Treo, a Blackberry, a Razor-type phone, etc. In general, this adaptation of the body portion involves making the body at least one of wider, taller and deeper. In some instances, for some of the slim-style cell phones, the body is made thinner to accommodate, engage and hold the thinner body of the cell phone in the cell phone neck sleeve.

Embodiments of the present invention may be manufactured from a variety of different styles of materials and fabrics, for example, a pliable clear vinyl and/or plastic may be used for the front of the body portion as well as the picture cover that may be placed on the back of the body portion. In some embodiments, the back of the body portion may be made from any substantially non-stretch fabric and may include two pieces of fabric sewn together. In these embodiments, the front may be sewn between the two pieces of the back to securely fix the front and back together. However, alternative embodiments may use any and all fabrics, for example, in some alternative embodiments, the fabric used for the back may be a wide elastic webbing. In such embodiments, the size of the back may be less than in embodiments made with non-stretch fabric to ensure that the body portion fits snuggly and securely around the base of the cell phone.

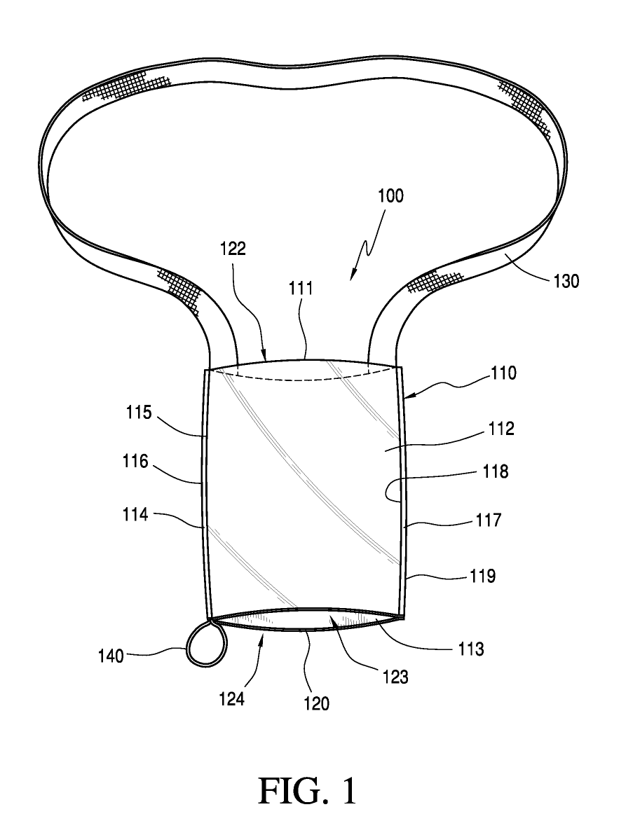

FIG. 1 is a front view of an electronic component carrying neck sleeve, for example, but not limited to, a cell phone neck sleeve, in accordance with an embodiment of the present invention. In FIG. 1, a cell phone neck sleeve 100 may include a body portion 110 having a top 111, a front 112, a back 113, a left side 114 connected to a left edge 115 of the front 112 and a left edge 116 of the back 113, a right side 117 connected to a right edge 118 of the front 112 and a right edge 119 of the back 113, and a bottom 120. Top edges of each of the front 112, the left side 114, the right side 117 and the back 120 form an opening 122 at the top 111 into a channel 123 within the cell phone neck sleeve 100. Likewise, bottom edges of each of the front 112, the left side 114, the right side 117 and the back 120 form an opening 124 at the bottom 120 into the channel 123 within the cell phone neck sleeve 100. In general, the body portion 110 may be slightly tapered inward at the bottom opening 124. This tapering helps to hold the cell phone in the cell phone neck sleeve 100. The use of sides 114, 117 permits thicker cell phones to be accommodated in the cell phone neck sleeve 100, however, embodiments are also contemplated without separate side sections.

In accordance with at least one embodiment of the present invention, back 113 may be made from fabric, elastic, elasticized fabric, fabric and rubber or some other non-slip material to aid in keeping the cell phone held securely in the cell phone neck sleeve 100. Optionally, the cell phone neck sleeve 100 may include an elastic loop 140 on the lower end of the left side 114 and/or the right side 117 that is adapted to stretch over and secure a cell phone antenna to help hold the cell phone in the cell phone neck sleeve 100.

IN FIG. 1, a fabric strap 130 may be attached to top ends of each of the left side 114 and the right side 117 at outer edges of the top of the body portion to form a loop. The loop of the fabric strap 130 may be adapted to fit around a person's neck, which results in the cell phone hanging upside down and being in a position to be immediately used with minimal effort. In general, the fabric strap 130 may be from approximately 15 to 24 inches in length The fabric strap 130 may be further adapted to be adjustable in length, so individual users can adjust where the body portion falls on their torso between their shoulders and waist. For example, the fabric strap 130 may include an adjustable component, such as, an adjustable buckle component, a ring and hook and pile fastening component, a tri-glide strap adjuster, a ladder lock, and/or a cinch lock. Alternatively, cord locks could be used in approximately the center of the fabric strap 130 to adjust the size of the opening created by the fabric strap 130.

In the embodiment in FIG. 1, as well as in other embodiments, the cell phone neck sleeve may further include a separate clear soft piece of vinyl or other clear protective material that is adapted to be secured to the top or front of the flip-type cell phone that is not inside the body portion. This piece of vinyl is adapted to provide protection for the top or front of the flip-type phone. In alternative embodiments the front 112 may be adapted to include the clear soft piece of vinyl.

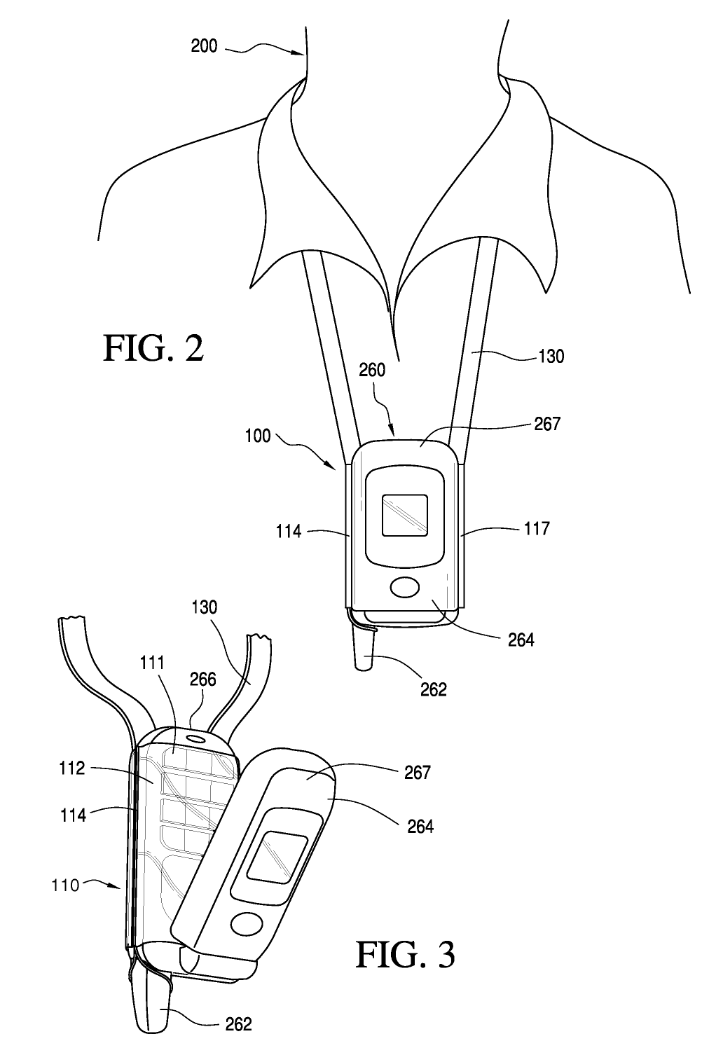

FIG. 2 is a front view of a flip-style cell phone in the cell phone neck sleeve of FIG. 1 being worn around the neck of a person, in accordance with an embodiment of the present invention. In FIG. 2, the cell phone neck sleeve 100 of FIG. 1 is shown with a cell phone 260 installed inside body 110 and the fabric strap 130 around a user's neck 200. Specifically, the cell phone 260 is seen to be in an upside-down position with its antenna 262 pointing downward and away from the user's neck 200. In this position, to open a cell phone flip top 264 of cell phone 260, a user only needs to open the cell phone flip top 264 by pushing a bottom portion 267 of the cell phone flip top 264 down and away from the user's neck 200. A partially opened cell phone is seen in FIG. 3.

FIG. 3 is a front perspective view of the flip-style cell phone and the cell phone neck sleeve of FIG. 2 showing the flip-style cell phone partially open, in accordance with an embodiment of the present invention. In FIG. 3, the cell phone 260 is shown with cell phone flip top portion 264 in a partially opened position that has uncovered cell phone base 266, which is frictionally held in the body 110 of the cell phone neck sleeve 100.

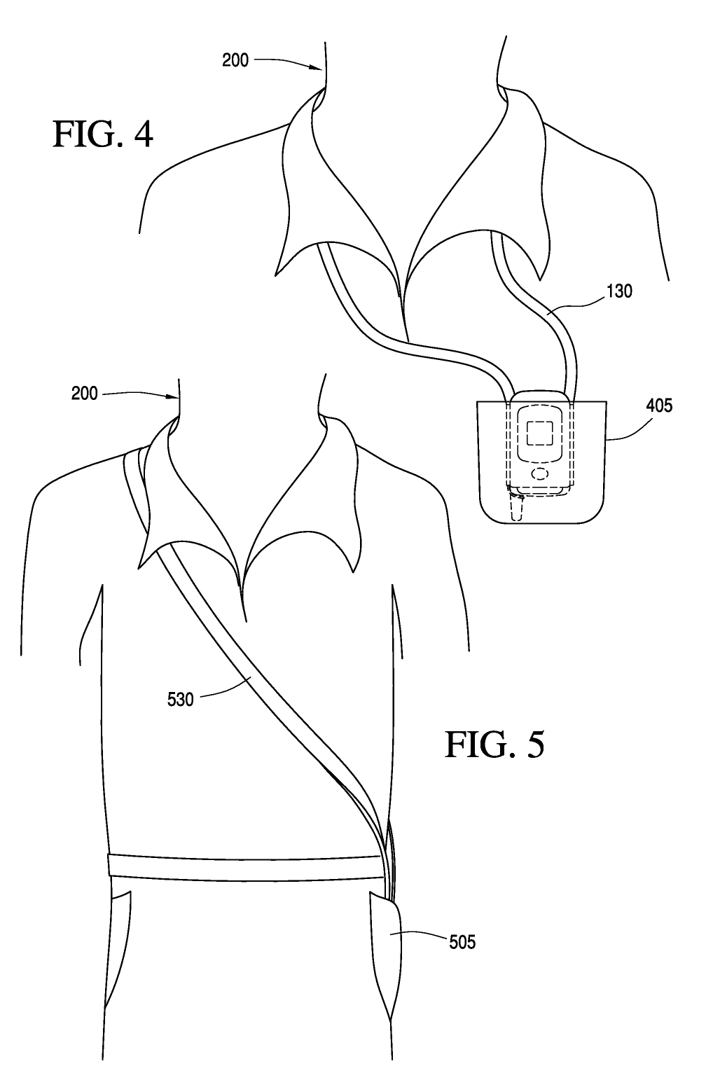

FIG. 4 is a front view of a person with a strap from a cell phone neck sleeve hanging around a person's neck and the cell phone neck sleeve with a cell phone installed therein stored in a shirt breast-pocket of the person, in accordance with an embodiment of the present invention. In FIG. 4, the strap 130 of the cell phone neck sleeve 100 is shown around the user's neck 200 and the cell phone neck sleeve and the cell phone (shown in shadow line) are stored in the user's shirt breast pocket 405.

FIG. 5 is a front view of a person with a strap from a cell phone neck sleeve hanging around a person's neck and the cell phone neck sleeve with a cell phone installed therein stored in a shirt side-pocket of the person, in accordance with an embodiment of the present invention. In FIG. 5, the cell phone neck sleeve 100 is shown with an extended fabric strap 530, which enables the user to store the cell phone neck sleeve and the cell phone (not shown) in the user's shirt side pocket 505.

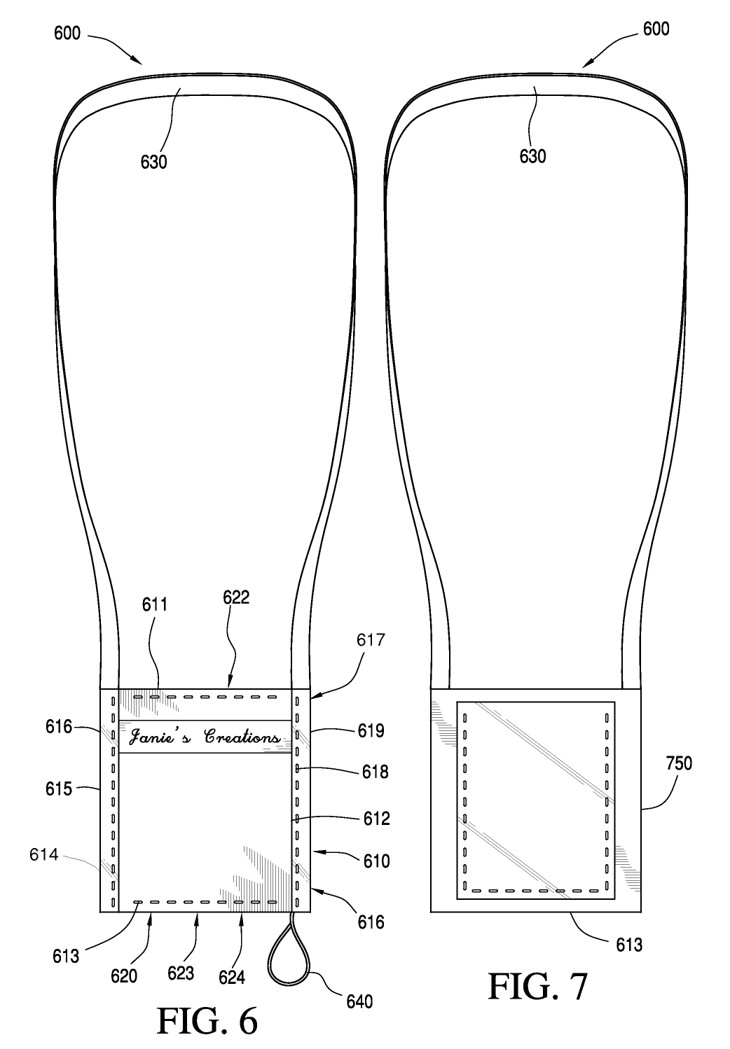

FIG. 6 is a front view of a picture of an actual cell phone neck sleeve, in accordance with an embodiment of the present invention. In FIG. 6, a cell phone neck sleeve 600 may include a body portion 610 having a top 611, a front 612, a back 613 with a left edge 616 connected to a left edge 615 of the front 612 and a right edge 619 of the back 613 connected to a right edge 618 of the front 612, and a bottom 620. Top edges of each of the front 612 and the back 620 form a top opening 622 into a channel 623 within the cell phone neck sleeve 600. Likewise, bottom edges of each of the front 612 and the back 620 form a bottom opening 624 into the channel 623 within the cell phone neck sleeve 600. In general, the body portion 610 may be slightly tapered inward at the bottom opening. This tapering helps to hold the cell phone in the cell phone neck sleeve.

In accordance with at least one embodiment of the present invention, back 613 may be made from fabric, elastic, elasticized fabric, fabric and rubber or some other non-slip material to aid in keeping the cell phone held securely in the cell phone neck sleeve 600. Optionally, the cell phone neck sleeve 600 may include an elastic loop 640 on the lower end of the left side 614 and/or the right side 617 that is adapted to stretch over and secure a cell phone antenna to help hold the cell phone in the cell phone neck sleeve 600.

IN FIG. 6, a fabric strap 630 may be attached to top ends of the back 613 at outer edges of the top of the body portion to form a loop. The loop of the fabric strap 630 may be adapted to fit around a person's neck, which results in the cell phone hanging upside down and being in a position to be immediately used with minimal effort. In general, the fabric strap 630 may be from approximately 15 to 24 inches in length The fabric strap 630 may be further adapted to be adjustable in length, so individual users can adjust where the body portion falls on their torso between their shoulders and waist. For example, the fabric strap 630 may include an adjustable component, such as, an adjustable buckle component, a ring and hook and pile fastening component, a tri-glide strap adjuster, a ladder lock, and/or a cinch lock. Alternatively, cord locks could be used in approximately the center of the fabric strap 630 to adjust the size of the opening created by the fabric strap 630.

In the embodiment in FIG. 6, as well as in other embodiments, the cell phone neck sleeve may further include a separate clear soft piece of vinyl or other clear protective material that is adapted to be secured to the top or front of the flip-type cell phone that is not inside the body portion. This piece of vinyl is adapted to provide protection for the top or front of the flip-type phone. In alternative embodiments the front 612 may be adapted to include the clear soft piece of vinyl.

FIG. 7 is a back view of a picture of an actual cell phone neck sleeve, in accordance with an embodiment of the present invention. In FIG. 7, the cell phone neck sleeve 600 is seen to include a clear pocket 750 on the back 613 such that the clear pocket 750 is fastened around three sides to back 613. The fourth side is left open to permit the insertion into the clear pocket 750 of substantially flat items, for example, but not limited to, pictures, important and/or emergency phone numbers, and the like.

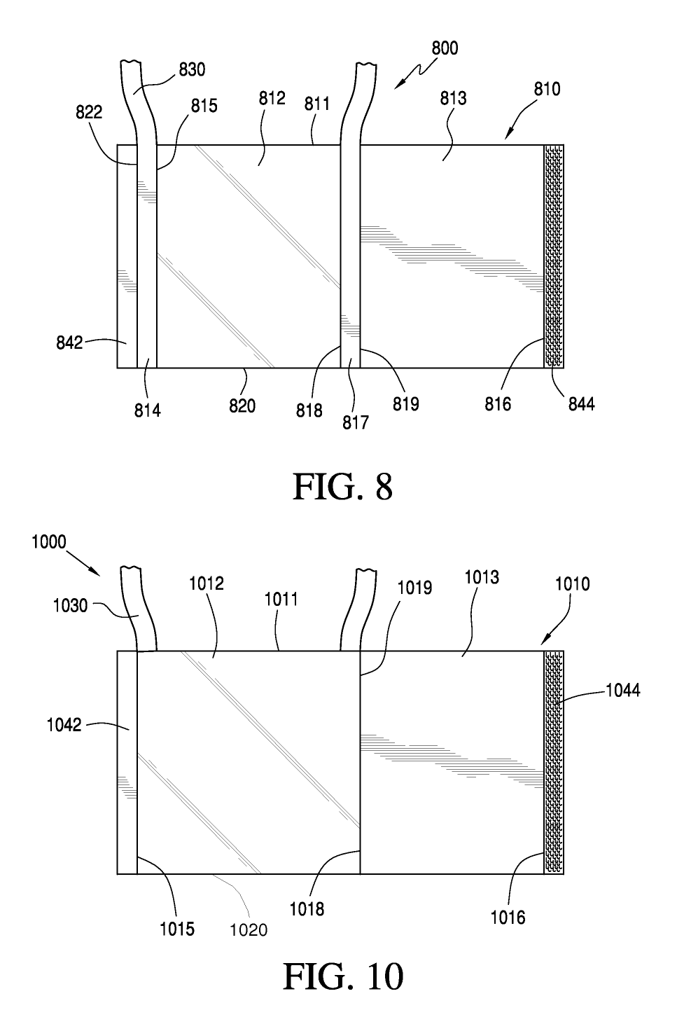

FIG. 8 is a view of an inside surface of a cell phone neck sleeve that opens with the use of a hook and loop fabric closure or some other closing means attached to one side and to an adjacent edge of the back of the cell phone neck sleeve to permit the easy insertion and/or removal of a cell phone from the cell phone neck sleeve, in accordance with another embodiment of the present invention. In FIG. 8, a cell phone neck sleeve 800 may include a body portion 810 having a top 811, a front 812, a back 813, a left side 814 connected to a left edge 815 of the front 812, a right side 817 connected to a right edge 818 of the front 812 and a right edge 819 of the back 813, and a bottom 120. A first disengagable fastening portion 842 is connected to a left edge 822 of the left side 814, with an operative side of the first disengagable fastening portion 842 on a back side of the first disengagable fastening portion 842 and not seen in FIG. 8. Similarly, a second disengagable fastening portion 844 is connected to a left edge 816 of the back 813, with an operative side of the second disengagable fastening portion 844 on a front side of the second disengagable fastening portion 844. When first disengagable fastening portion 842 and second disengagable fastening portion 844 are joined together top edges of each of the front 812, the left side 814, the right side 817 and the back 820 form an opening 822 at the top 811 into a channel 823 within the cell phone neck sleeve 800 similar to that shown in FIG. 1. Likewise, bottom edges of each of the front 812, the left side 814, the right side 817 and the back 820 form an opening 824 at the bottom 820 into the channel 823 within the cell phone neck sleeve 800 similar to that shown in FIG. 1. In general, the body portion 810 may be slightly tapered inward at the bottom opening 824. This tapering helps to hold the cell phone in the cell phone neck sleeve 800. The use of sides 814, 817 permits thicker cell phones to be accommodated in the cell phone neck sleeve 800, however, embodiments are also contemplated without separate side sections.

In accordance with at least one embodiment of the present invention, back 813 may be made from fabric, elastic, elasticized fabric, fabric and rubber or some other non-slip material to aid in keeping the cell phone held securely in the cell phone neck sleeve 800. Optionally, the cell phone neck sleeve 800 may include an elastic loop 840 on the lower end of the left side 814 and/or the right side 817 that is adapted to stretch over and secure a cell phone antenna to help hold the cell phone in the cell phone neck sleeve 800.

IN FIG. 8, a fabric strap 830 may be attached to top ends of each of the left side 814 and the right side 817 at outer edges of the top of the body portion to form a loop. The loop of the fabric strap 830 may be adapted to fit around a person's neck, which results in the cell phone hanging upside down and being in a position to be immediately used with minimal effort. In general, the fabric strap 830 may be from approximately 15 to 24 inches in length The fabric strap 830 may be further adapted to be adjustable in length, so individual users can adjust where the body portion falls on their torso between their shoulders and waist. For example, the fabric strap 830 may include an adjustable component, such as, an adjustable buckle component, a ring and hook and pile fastening component, a tri-glide strap adjuster, a ladder lock, and/or a cinch lock. Alternatively, cord locks could be used in approximately the center of the fabric strap 830 to adjust the size of the opening created by the fabric strap 830. Although fabric strap 830 is shown in FIG. 8 as being attached to the tops of the left side 814 and the right side 817, it may also be attached to the top of the back 813 and/or front 812.

In the embodiment in FIG. 8, as well as in other embodiments, the cell phone neck sleeve may further include a separate clear soft piece of vinyl or other clear protective material that is adapted to be secured to the top or front of the flip-type cell phone that is not inside the body portion. This piece of vinyl is adapted to provide protection for the top or front of the flip-type phone. In alternative embodiments the front 812 may be adapted to include the clear soft piece of vinyl.

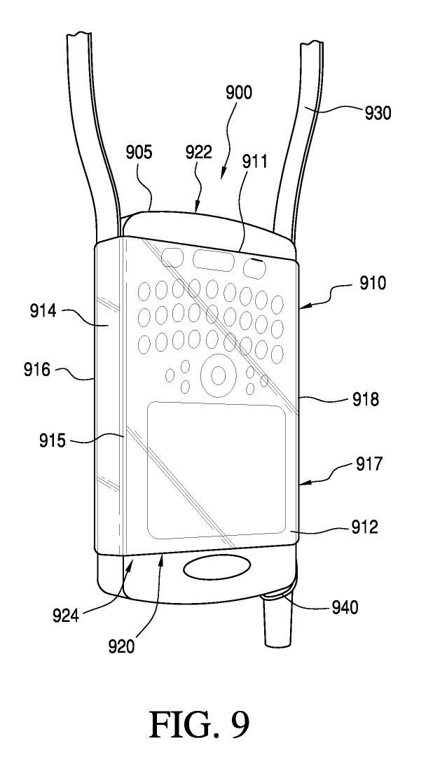

FIG. 9 is a front perspective view of a straight, non-flip-style cell phone in a cell phone neck sleeve, in accordance with an embodiment of the present invention. In FIG. 9, a cell phone neck sleeve 900 is shown with a straight cell phone 905 installed in the cell phone neck sleeve 900. This embodiment of the cell phone neck sleeve 900 is similar to the embodiment of FIG. 1, with the exception that the separate clear soft piece of vinyl or other clear protective material described with the other embodiments that is adapted to be secured to the top or front of the flip-type cell phone that is not required in the embodiment of FIG. 9.

In FIG. 9, a cell phone neck sleeve 900 may include a body portion 910 having a top 911, a front 912, a back (hidden by a cell phone 905), a left side 914 connected to a left edge 915 of the front 912 and a left edge 916 of the back, a right side 917 connected to a right edge 918 of the front 912 and a right edge of the back (hidden by cell phone 905), and a bottom 920. Top edges of each of the front 912, the left side 914, the right side 917 and the back form an opening 922 at the top 911 into a channel 923 within the cell phone neck sleeve 900. Likewise, bottom edges of each of the front 912, the left side 914, the right side 917 and the back form an opening 924 at the bottom 920 into the channel 923 within the cell phone neck sleeve 900. In general, the body portion 910 may be slightly tapered inward at the bottom opening 924. This tapering helps to hold the cell phone in the cell phone neck sleeve 900. The use of sides 914, 917 permits thicker cell phones to be accommodated in the cell phone neck sleeve 900, however, embodiments are also contemplated without separate side sections for use with thinner straight cell phones.

In accordance with at least one embodiment of the present invention, the back may be made from fabric, elastic, elasticized fabric, fabric and rubber or some other non-slip material to aid in keeping the cell phone held securely in the cell phone neck sleeve 900. Optionally, the cell phone neck sleeve 900 may include an elastic loop 940 on the lower end of the left side 914 and/or the right side 917 that is adapted to stretch over and secure a cell phone antenna to help hold the cell phone in the cell phone neck sleeve 900.

In FIG. 9, a fabric strap 930 may be attached to top ends of each of the left side 914 and the right side 917 at outer edges of the top of the body portion to form a loop. The loop of the fabric strap 930 may be adapted to fit around a person's neck, which results in the cell phone hanging upside down and being in a position to be immediately used with minimal effort. In general, the fabric strap 930 may be from approximately 15 to 24 inches in length The fabric strap 930 may be further adapted to be adjustable in length, so individual users can adjust where the body portion falls on their torso between their shoulders and waist. For example, the fabric strap 930 may include an adjustable component, such as, an adjustable buckle component, a ring and hook and pile fastening component, a tri-glide strap adjuster, a ladder lock, and/or a cinch lock. Alternatively, cord locks could be used in approximately the center of the fabric strap 930 to adjust the size of the opening created by the fabric strap 930. Although fabric strap 930 is shown in FIG. 9 as being attached to the tops of the left side 914 and the right side 917, it may also be attached to the top of the back 913 and/or front 912.

FIG. 10 is a view of an inside surface of a cell phone neck sleeve that opens with the use of a hook and loop fabric closure (e.g., Velcro) or some other closing means attached to one side and to an adjacent edge of the back of the cell phone neck sleeve to permit the easy insertion and/or removal of a cell phone from the cell phone neck sleeve, in accordance with yet another embodiment of the present invention. In FIG. 10, a cell phone neck sleeve 1000 may include a body portion 1010 having a top 1011, a front 1012, a back 1013 having a right edge 1019 connected to a right edge 1018 of the front 1012, and a bottom 120. A first disengagable fastening portion 1042 is connected to a left edge 1015 of the front 1012, with an operative side of the first disengagable fastening portion 1042 on a back side of the first disengagable fastening portion 1042 and not seen in FIG. 8. Similarly, a second disengagable fastening portion 1044 is connected to a left edge 1016 of the back 1013, with an operative side of the second disengagable fastening portion 1044 on a front side of the second disengagable fastening portion 1044. When first disengagable fastening portion 1042 and second disengagable fastening portion 1044 are joined together top edges of each of the front 1012 and the back 1020 form an opening 1022 at the top 1011 into a channel 1023 within the cell phone neck sleeve 1000 similar to that shown in FIG. 6. Likewise, bottom edges of each of the front 1012 and the back 1020 form an opening 1024 at the bottom 1020 into the channel 1023 within the cell phone neck sleeve 1000 similar to that shown in FIG. 6. In general, the body portion 1010 may be slightly tapered inward at the bottom opening 1024. This tapering helps to hold the cell phone in the cell phone neck sleeve 1000.

In accordance with at least one embodiment of the present invention, back 1013 may be made from fabric, elastic, elasticized fabric, fabric and rubber or some other non-slip material to aid in keeping the cell phone held securely in the cell phone neck sleeve 1000. Optionally, the cell phone neck sleeve 1000 may include an elastic loop 1040 on the lower end of the left side 1014 and/or the right side 1017 that is adapted to stretch over and secure a cell phone antenna to help hold the cell phone in the cell phone neck sleeve 1000.

IN FIG. 10 a fabric strap 1030 may be attached to top ends of each of the left side 1014 and the right side 1017 at outer edges of the top of the body portion to form a loop. The loop of the fabric strap 1030 may be adapted to fit around a person's neck, which results in the cell phone hanging upside down and being in a position to be immediately used with minimal effort. In general, the fabric strap 1030 may be from approximately 15 to 24 inches in length The fabric strap 1030 may be further adapted to be adjustable in length, so individual users can adjust where the body portion falls on their torso between their shoulders and waist. For example, the fabric strap 1030 may include an adjustable component, such as, an adjustable buckle component, a ring and hook and pile fastening component, a tri-glide strap adjuster, a ladder lock, and/or a cinch lock. Alternatively, cord locks could be used in approximately the center of the fabric strap 1030 to adjust the size of the opening created by the fabric strap 1030. Although fabric strap 1030 is shown in FIG. 10 as being attached to the top of the front 1012, it may also be attached to the top of the back 1013.

In the embodiment in FIG. 10, as well as in other embodiments, the cell phone neck sleeve may further include a separate clear soft piece of vinyl or other clear protective material that is adapted to be secured to the top or front of the flip-type cell phone that is not inside the body portion. This piece of vinyl is adapted to provide protection for the top or front of the flip-type phone. In alternative embodiments the front 1012 may be adapted to include the clear soft piece of vinyl.

Still other embodiments are contemplated by modifying any of the above described embodiments to permit an open area to be defined in the front of each to permit direct access to some or all keys and/or buttons on the face of the device in the sleeve.

In accordance with an embodiment of the present invention, an electronic component holder includes a body portion having a top, a front, a back, a left side connected to a left edge of the front and a left edge of the back, a right side connected to a right edge of the front and a right edge of the back, and a bottom. The body portion tapering inwardly from the top to the bottom and defining an open channel between the top and the bottom, where the body channel is adapted to securely receive and retain an electronic component. The electronic component holder also includes a fabric strap having a left end and a right end, where the left end and the right end of the fabric strap are each attached to the top end of the body portion.

In accordance with an embodiment of the present invention, an electronic component holder includes a body portion having a top, a bottom, a front including a left edge and a right edge, a front side flap having a hook material on one side facing in a first direction and connected to the left edge of the front, and a back including a left edge and a right edge, a back side flap having a loop material on a side opposite the one side with the hook material, the right edge of the front being connected to the right edge of the back. The body portion being tapered inwardly from the top to the bottom and when folded so that the hook material on the front side flap engages the loop material on the back side flap to form an open channel between the top and the bottom and the open channel being adapted to securely receive and retain an electronic component. The electronic component holder also includes a fabric strap having a left end and a right end, where the left end and the right end of the fabric strap are each attached to the top end of the body portion.

In accordance with an embodiment of the present invention, an electronic component holder includes an a body portion having a top, a bottom, a front including a left edge and a right edge, and a back including a left edge and a right edge, the left edge of the front being connected to the left edge of the back and the right edge of the front being connected to the right edge of the back. The body portion tapering inwardly from the top to the bottom and forming an open channel between the top and the bottom and adapted to securely receive and retain an electronic component. The electronic component holder also includes a fabric strap having a left end and a right end, where the left end and the right end of the fabric strap are each attached to the top end of the body portion.

In accordance with an embodiment of the present invention, an electronic component holder includes a body portion having a top, a bottom, a front including a left edge and a right edge, a left side connected to a left edge of the front and a right edge of a front side flap having a hook material on one side facing in a first direction, a back including a left edge and a right edge, a right side connected to a right edge of the front and a left edge of the back, and left edge of a back side flap connected to the right edge of the back. The back side flap having a loop material on a side opposite the one side with the hook material, the body portion being tapered inwardly from the top to the bottom and when folded so that the hook material on the front side flap engages the loop material on the back side flap to form an open channel between the top and the bottom and the open channel being adapted to securely receive and retain an electronic component. The electronic component holder also includes a fabric strap having a left end and a right end, where the left end and the right end of the fabric strap are each attached to the top end of the body portion.

While the present invention has been described in conjunction with a number of embodiments, the invention is not to be limited to the description of the embodiments contained herein, but rather is defined by the claims appended hereto and their equivalents. It is further evident that many alternatives, modifications, and variations would be or are apparent to those of ordinary skill in the applicable arts. Accordingly, all such alternatives, modifications, equivalents, and variations that are within the spirit and scope of this invention.

What is claimed is:

1. An electronic component holder comprising:
a body portion having a top, a front, a back, a left side connected to a left edge of the front and a left edge of the back, a right side connected to a right edge of the front and a right edge of the back, and a bottom, the body portion being tapered inwardly from the top to the bottom and forming an open channel between the top and the bottom and adapted to securely receive and retain an electronic component; and
a fabric strap having a left end and a right end, where the left end and the right end of the fabric strap are each attached to the top end of the body portion.

2. The electronic component holder of claim 1 further comprising:
an elastic loop attached to a lower end of the left side, the elastic loop is adapted to stretch over and secure a cell phone antenna.

3. The electronic component holder of claim 1 wherein the back comprises:
fabric, elastic, elasticized fabric, fabric and rubber or some other non-slip material to aid in keeping the cell phone held securely in the electronic component holder.

4. The electronic component holder of claim 1 wherein the left end of the fabric strap is attached to a top end near the left edge of the back and the right end of the fabric strap is attached to a top end near the right edge of the back.

5. The electronic component holder of claim 1 wherein the left end of the fabric strap is attached to a top end of the left side and the right end of the fabric strap is attached to a top end of the right side.

6. The electronic component holder of claim 1 wherein the front comprises a flexible clear plastic to permit viewing of a portion of the electronic component immediately behind the front.

7. The electronic component holder of claim 6 wherein the flexible clear plastic permits a user to access the portion of the electronic component immediately behind the front by pressing on the flexible clear plastic above the portion of the electronic component to be accessed.

8. The electronic component holder of claim 1 wherein the back comprises an elastic material to stretch to receive and hold firmly in place a variety of electronic components.

9. The electronic component holder of claim 8 wherein the back further comprises a pocket to receive and hold firmly in place a variety of substantially flat items.

10. The electronic component holder of claim 9 wherein the pocket on the back comprises a clear plastic.

11. An electronic component holder comprising:
a body portion having a top, a bottom, a front including a left edge and a right edge, and a back including a left edge and a right edge, the left edge of the front being connected to the left edge of the back and the right edge of the front being connected to the right edge of the back, the body portion being tapered inwardly from the top to the bottom and forming an open channel between the top and the bottom and adapted to securely receive and retain an electronic component; and
a fabric strap having a left end and a right end, where the left end and the right end of the fabric strap are each attached to the top end of the body portion.

11. The electronic component holder of claim 11 further comprising:
an elastic loop attached to a lower end of the left side, the elastic loop is adapted to stretch over and secure a cell phone antenna.

12. The electronic component holder of claim 11 wherein the back comprises:
fabric, elastic, elasticized fabric, fabric and rubber or some other non-slip material to aid in keeping the cell phone held securely in the electronic component holder.

13. The electronic component holder of claim 11 wherein the left end of the fabric strap is attached to a top end near the left edge of the back and the right end of the fabric strap is attached to a top end near the right edge of the back.

14. The electronic component holder of claim 11 wherein the front comprises a flexible clear plastic to permit viewing of a portion of the electronic component immediately behind the front.

15. The electronic component holder of claim 14 wherein the flexible clear plastic permits a user to access the portion of the electronic component immediately behind the front by pressing on the flexible clear plastic above the portion of the electronic component to be accessed.

16. The electronic component holder of claim 1 wherein the back comprises an elastic material to stretch to receive and hold firmly in place a variety of electronic components.

17. An electronic component holder comprising:
a body portion having a top, a bottom, a front including a left edge and a right edge, a front side flap having a hook material on one side facing in a first direction and connected to the left edge of the front, and a back including a left edge and a right edge, a back side flap having a loop material on a side opposite the one side with the hook material, the right edge of the front being connected to the right edge of the back, the body portion being tapered inwardly from the top to the bottom and when folded so that the hook material on the front side flap engages the loop material on the back side flap to form an open channel between the top and the bottom and the open channel being adapted to securely receive and retain an electronic component; and
a fabric strap having a left end and a right end, where the left end and the right end of the fabric strap are each attached to the top end of the body portion.

18. The electronic component holder of claim 17 further comprising:
an elastic loop attached to a lower end of the left side, the elastic loop is adapted to stretch over and secure a cell phone antenna.

19. An electronic component holder comprising:
a body portion having a top, a bottom, a front including a left edge and a right edge, a left side connected to a left edge of the front and a right edge of a front side flap having a hook material on one side facing in a first direction, a back including a left edge and a right edge, a right side connected to a right edge of the front and a left edge of the back, and left edge of a back side flap connected to the right edge of the back, the back side flap having a loop material on a side opposite the one side with the hook material, the body portion being tapered inwardly from the top to the bottom and when folded so that the hook material on the front side flap engages the loop material on the back side flap to form an open channel between the top and the bottom and the open channel being adapted to securely receive and retain an electronic component; and
a fabric strap having a left end and a right end, where the left end and the right end of the fabric strap are each attached to the top end of the body portion.

20. The electronic component holder of claim 19 wherein the front has defined therein an opening to permit a user to directly access at least a portion of a face of an electronic component positioned behind the front.
